(19) United States
(12) Patent Application Publication
(10) Pub. No.: US 2017/0107053 A1
(43) Pub. Date: Apr. 20, 2017

(54) WASTE BIN WITH INJECTION-MOLDED PLASTIC BODY

(71) Applicant: FRITZ SCHÄFER GMBH, Neunkirchen (DE)

(72) Inventor: Diethelm HIRZ, Neunkirchen (DE)

(21) Appl. No.: 15/126,325

(22) PCT Filed: Apr. 14, 2015
(86) PCT No.: PCT/EP2015/058085

§ 371 Date: Sep. 29, 2016

(30) Foreign Application Priority Data
Apr. 16, 2014 (DE) 10 2014 207 355.3

(51) Int. Cl. B65F 1/02; B65F 1/14

(52) U.S. Cl. CPC B65F 1/02; B65F 1/14; B65F 2250/114

(57) ABSTRACT

The invention relates to a trash can (1) with an injection-molded plastic body (2) comprising side walls (3, 4, 5, 6) and a bottom wall (8) positioned relative to one another so as to together delimit a cavity (15) having an opening (17) opposite the bottom wall (8), the side walls (3, 4, 5, 6) integrally merging into the bottom wall (8) at their lower ends (10) adjacent the bottom wall (8), and each side wall (3, 4, 5, 6) merging into the adjacent side walls at common corners (11, 12, 13, 14), side walls (3, 4, 5) of the trash can (1) being corrugated in opposite directions between two corners (11, 12, 13, 14) in the width direction (25) of the respective side wall (3, 4, 5).

The invention relates to a trash can having an injection-molded plastic body comprising side walls and a bottom wall positioned relative to each other such that the side walls and the bottom wall together define a cavity having an opening opposite the bottom wall. The side walls integrally merge into the bottom wall at their lower ends, and each side wall merges with the adjacent side walls at common corners.

The trash cans in question are already known in the art. Such trash cans may be provided by municipalities for home use, with different filling capacities of 60 1, 120 1, 240 1, 360 1, or similar, for example, in order to store household trash, biological waste or similar, and for a disposal in return for payment.

DE 20 2013 000 851, for example, discloses a trash can made by injection molding in one piece of plastic. This trash can is essentially comprised of a bottom as well as four walls projecting upward therefrom. On its lower face, the bottom wall is provided with a stand strip on three sides of the trash can, on which the trash can sit when it is correctly placed on the floor. This stand strip is provided underneath corners between the front wall and side walls of the trash can with curved stand-strip segments joined by long straight segments of the stand strip.

The object of the invention is to improve on a trash can of this type and to facilitate its daily use.

This object of the invention is attained by a trash can with an injection-molded plastic body formed by side walls and a bottom wall positioned relative to each other such that the side walls and the bottom wall together define a cavity open away from the bottom wall. The side walls integrally merge into the bottom wall at their lower ends, and each side wall merges with the two adjacent side walls at common corners. The side walls of the trash can are curved many times in opposite directions between two corners in the width direction of the respective side wall.

Due to this corrugation of the side walls in opposite directions it is possible, with respect, in particular, to a maximum available width of such a side wall, to achieve a surface enlargement and therefore also more efficient material use for the same side wall width in the respective side wall, without thickening this side wall. The resulting trash can is therefore significantly stiffer, in particular with reference to a side wall that is entirely or only partially corrugated in opposite directions, than what is possible in case of a relatively completely plane side wall.

The stability may also be constructively increased simply by using thicker side walls. However, in order to achieve similar advantageous stability and/or resistance values, significantly more material would have to be used, and the trash can would become much heavier, and this would cause more difficulties in daily handling of the trash can.

Moreover, the trash can, in spite of its reinforced side walls, may be extracted without any undercut from a complementary injection mold.

In the case of a side wall at least partially corrugated in opposite directions, the corrugations cover width the side walls from a first corner all the way to a corner opposite this first corner. The full-width corrugations extend vertically the full height of the trash can.

It is already sufficient if some of side walls are at least partially formed with corrugations between two corners in order to provide the trash can according to the invention with better stability with respect to conventional planar side walls.

These side walls of the trash can are provided with corrugations preferably only in their lower third. Due to the corrugated construction obtained in this way, it is in particular possible to achieve an advantageous reinforcement of the side walls such that forces applied to the plastic body of the trash can in case of an impact of the trash can, in particular in one of the corners, on a floor or similar are distributed in a very smooth way to the overlying planar side wall regions.

In this sense, in a preferred embodiment the side walls of the trash can have a corrugated shape between two corners in the width direction of the respective side wall. The corrugations advantageously extend between two corners with a certain periodicity in the width direction. In case of an at least partially corrugated side wall, the profile of the wave peaks and troughs is directed in the width direction of side walls from a first corner to a corner opposite to the first corner. This means that the width direction of wave peaks or troughs is directed in the direction of the total height of the trash can.

It is particularly advantageous if side walls of the trash can are provided between two corners in the width direction of respective side walls with regions that are alternately concave and convex. In this way, a greater quantity of material may be accumulated with respect to the width of the side wall so that the side wall is overall stiffer.

If the front side wall and the lateral side walls are provided, between two corners, in the width direction of the respective side wall, with a different number of wave troughs and peaks, the front side wall, which is frequently subject to higher loads, may be rendered stiffer due to a larger material accumulation with respect to its width. The less loaded lateral walls may instead be provided with less material; these lateral side walls may be nonetheless provided with corrugations or waves.

Preferably, in the front side wall between two corners in the width direction of the respective side wall a total of at least six, preferably seven, wave peaks and troughs are provided, whereas on the lateral side walls between two corners in the width direction only a maximum of five wave peaks and troughs are provided.

Side walls of the trash can are advantageously provided, in their lower third, in the width direction of the respective side wall with a labyrinthine side wall cross section. In this way extremely stable and solid merge regions may be created between these side walls and the bottom wall.

It is also advantageous if the front side wall is provided with a tighter labyrinthine side wall cross section than the lateral side walls. In this way, the usually more loaded front side wall may be stiffer and robust, whereas the less loaded lateral side walls may be lighter, although stiffer and more robust than before due to a further labyrinthine cross-section. According to a further advantageous embodiment a merge region between the side walls and the bottom wall is provided with waves and troughs in opposite directions or corrugations. The trash can may therefore be in particular reinforced on its lower side.

If the front side wall is also provided where it merges with the bottom wall with a labyrinthine cross section that is different with respect to the lateral walls, then this often more loaded merge region may be provided also with a higher stability and resistance.

A further preferred embodiment envisages that the bottom wall is provided with an enveloping edge that is provided with multiple in oppositely curved or corrugated edge segments, so that the bottom wall may also be reinforced according to the invention.

If the multiply opposite curved or corrugated edge segments and the at least partially multiple opposite curved or corrugated side walls have the same curvature, it is possible to easily produce very stable merge regions between these side walls and the bottom wall.

In this context, it is advantageous, if the multiple opposite curved or corrugated edge segments of the bottom wall are positioned more toward the inside than the multiple opposite curved or corrugated lateral walls. In this way merge regions with an advantageous radius may be created, so that there is between the bottom wall and the corresponding side walls a better force flow in the material.

Moreover, it is advantageous if the bottom wall is provided with a plurality of wave peaks and troughs, which, starting from a central area of the bottom wall, in the respective width direction, extend like spokes up to the merge region between the bottom wall and the side walls. The individual peaks and troughs are concentrically arranged around this central area or injection point. Only in this way it is possible to further develop a trash can of this kind, so that this combination of characteristics is advantageous even without the other characteristics of the invention.

Further characteristics, effects and advantages of this invention are explained with reference to the attached drawing and the following description, in which an embodiment of a trash can according to the invention is shown and described.

In the drawing, in particular:

FIG. 1 is a schematic and perspective view of a trash can with three side walls joined at two corners and corrugated in the width direction the side walls;

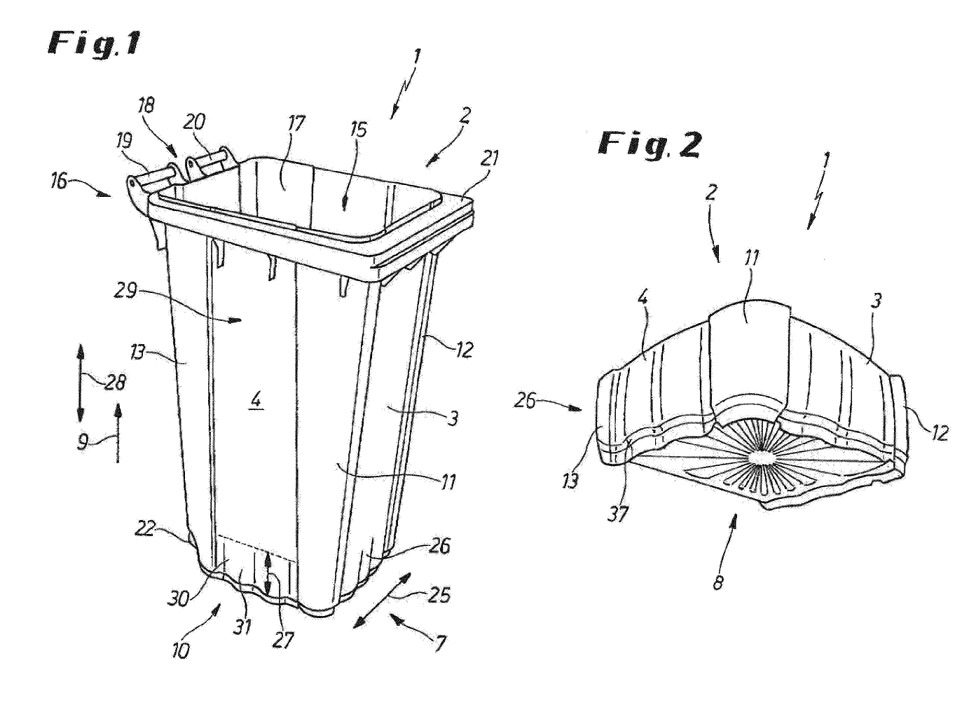

FIG. 2 is a schematic perspective view of the bottom wall of the trash can of FIG. 1,

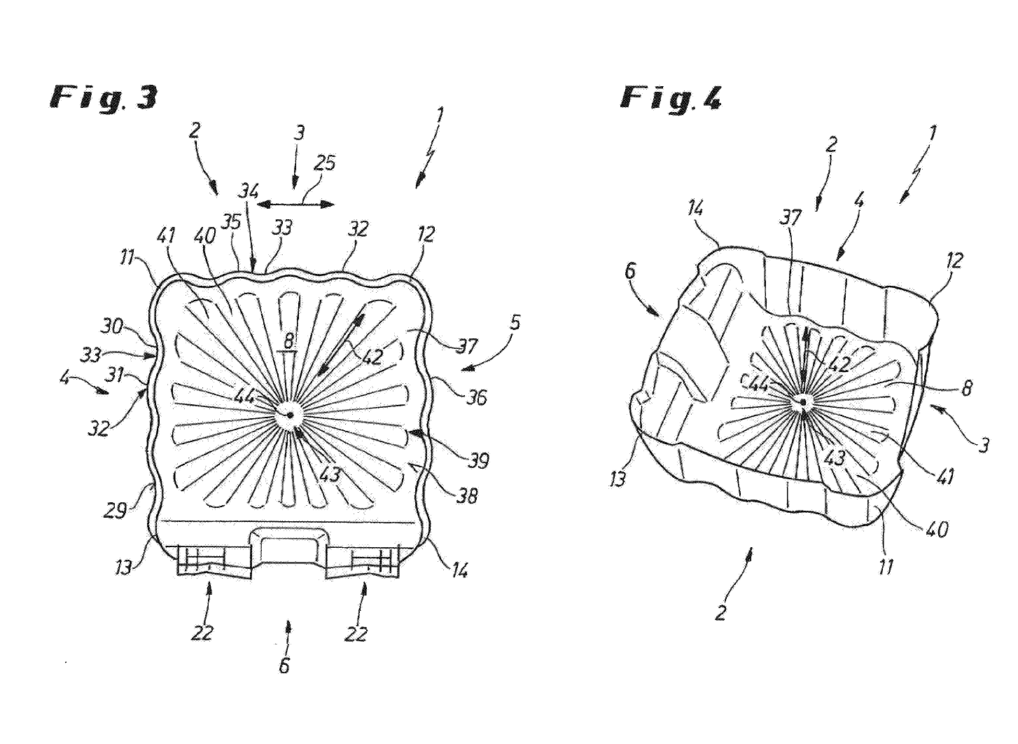

FIG. 3 a schematic bottom view of the bottom wall of the trash can, of FIGS. 1 and 2; and

FIG. 4 is a further schematic and perspective cross- sectional view of a lower part of the trash can of FIGS. 1 to 3.

The trash can 1 shown in FIG. 1 is provided with an injection-molded plastic body 2. This injection-molded plastic body 2 forms side walls 3, 4, 5 and 6 of the trash can 1, i.e. a front side wall 3, a first lateral side wall 4, a second lateral side wall 5 and a back side wall 6. The trash can 1 is also provided on its underside 7 with a bottom wall 8 also formed by the injection-molded plastic body 2. The side walls 3, 4, 5 and 6 extend from the bottom wall 8 upward in a direction 9, and the side walls 3, 4, 5, 6 are integrally connected with this bottom wall 8 at their respective lower ends 10 (with exemplary numbering). Both lateral side walls 4 and 5 are connected in two front corners 11 and 12 of the trash can 1 to the front side wall 3 and in two back corners 13 and 14 of the trash can 1 are integrally connected to the opposite back side wall 6. The side walls 3, 4, 5 and 6 as well as the bottom wall 8 are positioned with respect to each other such that they define together a cavity 15 for holding trash. This cavity 15 may be accessed from the upper side 16 of the trash can 1 through an opening 17 and may be closed by an unillustrated lid. The lid may be rotatably attached by a support 18 embedded in two handles 19 and 20 of the trash can 1 on the same trash can 1. The opening 17 is surrounded by an overhang edge 21 that at the same time represents an upper end of the trash can 1 on which the lid is placed when the trash can 1 is closed. At the same time, the overhang edge 21 allows the insertion of lifting devices for picking up the trash can 1, for example when emptying the trash can 1 into a dumpster. An axial support 22 is also provided (see also FIGS. 2 and 4) on the back side wall 6 above the bottom wall 8 for holding an unillustrated wheel axle, so that the trash can 1 may also roll.

As can readily be seen in FIGS. 1 to 4, the front side wall 3 and both lateral side walls 4 and 5 in this example are provided with corrugations between the two corners 11 and 12 (front side wall 3), 11 and 13 (first lateral side wall 4) and 12 and 14 (second lateral side wall), in a width direction 25 (illustrated for side wall 3 only, see in particular FIG. 3) of these side walls 3, 4 and 5, at least in a region 26 at their lower ends 10 close to the bottom wall 8. In this way, these side walls 3, 4 and 5 achieve a higher resistance and therefore the trash can 1 has an overall higher rigidity. Above these regions 26, these side walls 3, 4 and 5 have a more planar form, so that they are produced there with less material. This region 26 in this example is characterized by a height 27 that is approximately 1/9 of the entire height 28 of the respective side wall 3, 4 or 5. These side walls 3, 4 and 5 are provided, between the respective two corners 11 and 12, 11 and 13 and 12 and 14 in the width direction 25, with alternating valleys 30 and ridges 31, and the ridges 31 form corresponding peaks 32 and the valleys 30 corresponding wave troughs 33 on the side walls 3, 4 and 5. For example, the front side wall 29 of the trash can 1 is formed on this outer side 29 with three peaks 32 and four troughs 33. Both lateral side walls 4 and 5, between the respective corners 11 and 13, 12 and 14 on the outer side 29 are formed with only two peaks 32 and three troughs 33. In this sense, these side walls 3, 4 and 5 are provided in the width direction 26 of the respective side wall with a labyrinthine side wall cross section 34, and the front side wall 3 is provided with a tighter labyrinthine side wall cross section 35 than the lateral side walls 4 and 5 which have a wider labyrinthine cross section 36 (numbered for illustrative purposes only). Moreover, a merge region 37 (numbered for illustrative purposes only) is also formed with a corrugation between the side walls 3, 4 and 5 and corrugated edge segments 38 (numbered for illustrative purposes only) of an edge 39 enveloping the bottom wall 8 (see in particular FIG. 3).

In particular, the bottom wall 8 is also reinforced in that it is provided with a plurality of further wave peaks 40 and troughs 41 that extend, with respect to their respective width direction 42 (shown for illustrative purposes only), starting from a central area 43 of the bottom wall 8 and in this example also from an injection point 44 provided on the bottom wall 8, like spokes to the merge region 37 between the bottom wall 8 and the side walls 3, 4, 5 and 6.

It is understood that this embodiment is only a first embodiment of the inventive trash can. In this sense, the invention is not limited to this illustrated embodiment.

All characteristics that are disclosed in the application files are claimed as essential to the invention, provided that they, individually or in combination, are new with respect to the prior art.

| | |
|---|---|
| 1 | trash can |
| 2 | plastic body |
| 3 | front side wall |
| 4 | first lateral side wall |
| 5 | second lateral side wall |
| 6 | back side wall |
| 7 | underside |
| 8 | bottom wall |
| 9 | direction |
| 10 | lower ends |
| 11 | first front corner |
| 12 | second front corner |
| 13 | first back corner |
| 14 | second back corner |
| 15 | cavity |
| 16 | upper side |
| 17 | opening |
| 18 | support |
| 19 | first handle |
| 20 | second handle |
| 21 | overhang edge |
| 22 | axial support |
| 25 | width direction |
| 26 | region |
| 27 | region height |
| 28 | total height |
| 29 | outer side |
| 30 | valleys |
| 31 | ridges |
| 32 | wave peaks |
| 33 | wave troughs |
| 34 | labyrinthine side wall cross |
| | section |
| 35 | tight labyrinthine side wall |
| | cross section |
| 36 | wide labyrinthine side wall |
| | cross section |
| 37 | merge region |
| 38 | edge segments |
| 39 | enveloping edge |
| 40 | further wave peaks |
| 41 | further wave troughs |
| 42 | width direction |
| 43 | central area |
| 44 | injection point |

1. A trash can having an injection-molded plastic body comprising:
a front side wall, an opposite back side wall and two lateral side walls bridging the front and back side walls; and
a bottom wall positioned relative to the side walls so as to together delimit a cavity having an opening opposite the bottom wall, the side walls integrally merging into the bottom wall at their lower ends adjacent the bottom wall, and each side wall merging integrally into the adjacent side walls at common corners, the side walls of the trash can being corrugated in opposite directions between the respective corners in the width direction of the respective side wall and only in their lower third.

2. (canceled)

3. The trash can according to claim 1, wherein the side walls of the trash can are corrugated between two corners in the width direction of the respective side wall.

4. The trash can according to claim 1, wherein the side walls of the trash can are provided with alternating valleys and ridges between two corners in the width direction of the respective side wall.

5. The trash can according to claim 1, wherein the front side wall and lateral side walls are provided with different numbers of wave peaks and wave troughs between two corners in the width direction of the respective side wall.

6. The trash can according to claim 1, wherein the side walls of the trash can are provided with wave peaks and wave troughs between two corners in the width direction of the respective side wall.

7. The trash can according to claim 1, wherein the side walls of the trash can are provided with a labyrinthine side wall cross section in their lower third in the width direction of the respective side wall.

8. The trash can according to claim 1, wherein the front side wall has a tighter labyrinthine side wall cross section than the other side walls.

9. The trash can according to claim 1, wherein a merge region between the side walls and the bottom wall is corrugated in opposite directions or is corrugated.

10. The trash can according to claim 1, wherein the front side wall is provided, in a merge region with the bottom wall, with a labyrinthine side wall cross section differently shaped than the lateral side walls.

11. The trash can according to claim 1, wherein the bottom wall is provided with an enveloping edge provided with edge segments that are wavy in opposite directions or are corrugated.

12. The trash can according to claim 11, wherein edge segments are wavy in opposite directions or corrugated and the side walls are at least partially wavy in opposite directions or corrugated and have the same curvature.

13. The trash can according to claim 11, wherein the edge segments of the bottom wall are wavy in opposite directions or are corrugated and are disposed more toward the inside than the side walls that are wavy in opposite directions or corrugated.

14. The trash can according to claim 1, wherein the bottom wall is provided with a plurality of further wave peaks and troughs that extend, with respect to their respective width extension, starting from a central area of the bottom wall like spokes to merge regions between the bottom wall and the side walls.
